(19) United States
(12) Patent Application Publication
(10) Pub. No.: US 2007/0260431 A1
(43) Pub. Date: Nov. 8, 2007

(54) DUAL TIME/FREQUENCY FILTERING FOR IMPROVED DETECTION

(75) Inventor: Fatih M. Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/743,813

(22) Filed: May 3, 2007

Related U.S. Application Data
(60) Provisional application No. 60/797,576, filed on May 4, 2006.

(51) Int. Cl. H04B 15/00; G06F 19/00

(52) U.S. Cl. 702/191; 702/189; 702/190; 702/127

(57) ABSTRACT

The present invention improves detection of a wireless signal sequence by using dual time domain and frequency domain processing of the signal. Received components that do not exist in the reference sequence are canceled as a noise removal process in the first domain to produce a modified signal. The modified signal is converted to the second domain for signal data detection processing in the second domain with reduced noise.

### CROSS REFERENCE TO RELATED APPLICATIONS

This application claims the benefit of U.S. Provisional Application No. 60/797,576 filed May 4, 2006, which is incorporated by reference as if fully set forth.

### FIELD OF INVENTION

The present invention relates to wireless communications. More specifically, the present invention relates to detection of a signal, such as the synchronization channel, in wireless communications.

### BACKGROUND

One of the problems frequently encountered in communication system design is the detection of a known signal. This is the case for example when a receiver is attempting to detect the pilot, i.e. the reference signal, or the synchronization channel, from the base station and achieve synchronization.

General form of the solution involves searching for the known reference signal continuously until it is detected. This involves generating a detection metric such as a correction or materialized filter output. This is well known in the art and results from the formulation of the problem assuming Gaussian background.

Traditionally, a signal detector in time domain is used when searching a time domain sequence in CDMA systems, and sometimes frequency domain matched filtering is more appropriate such as in OFDM systems. There is however a duality between the time and frequency domain representations. Therefore, typically a signal detector is designed for processing in either time domain or frequency domain.

### SUMMARY

The present invention is a method and apparatus for improved detection of a reference signal transmitted in a wireless system. In a first embodiment, some of the noise in the frequency domain is removed, followed by performing signal detection in time domain. In a second embodiment, noise is removed in time domain, and signal detection is performed in the frequency domain.

### BRIEF DESCRIPTION OF THE DRAWINGS

A more detailed understanding of the invention may be had from the following description of a preferred embodiment, given by way of example and to be understood in conjunction with the accompanying drawing(s) wherein:

FIG. 1 shows an example of a time domain sequence;

FIG. 2 shows a frequency response corresponding to the time sequence of FIG. 1;

FIG. 3 shows an example of the time domain sequence shown in FIG. 1 with noise;

FIG. 4 shows an example of a frequency domain sequence as shown in FIG. 2 with noise;

FIG. 5 shows a block diagram of a dual time/frequency filtering and detection algorithm with time domain signal detection and noise removal in frequency domain;

FIG. 6 shows in greater detail the block diagram of the dual time/frequency filtering and detection algorithm of FIG. 5;

FIG. 7 shows a block diagram of a dual time/frequency filtering and detection algorithm with frequency domain signal detection and noise removal in time domain;

FIG. 8 shows in greater detail the block diagram of the dual time/frequency filtering and detection algorithm of FIG. 7.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Hereafter, the preferred embodiments are described in terms of a receiver, which may be implemented as a WTRU or a base station receiver which receives an uplink or a downlink communication.

The preferred embodiments of the present invention relate to removing noise prior to a signal sequence detection.

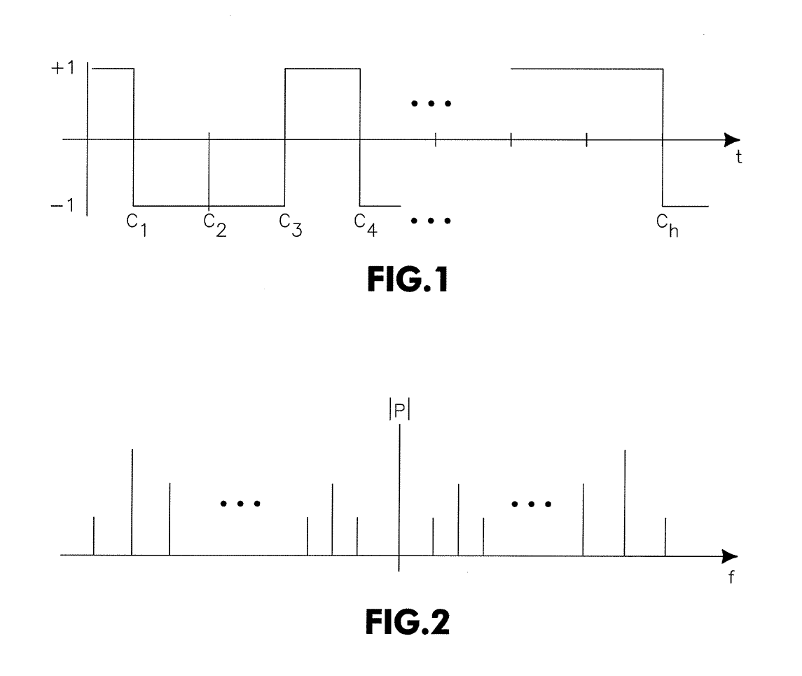

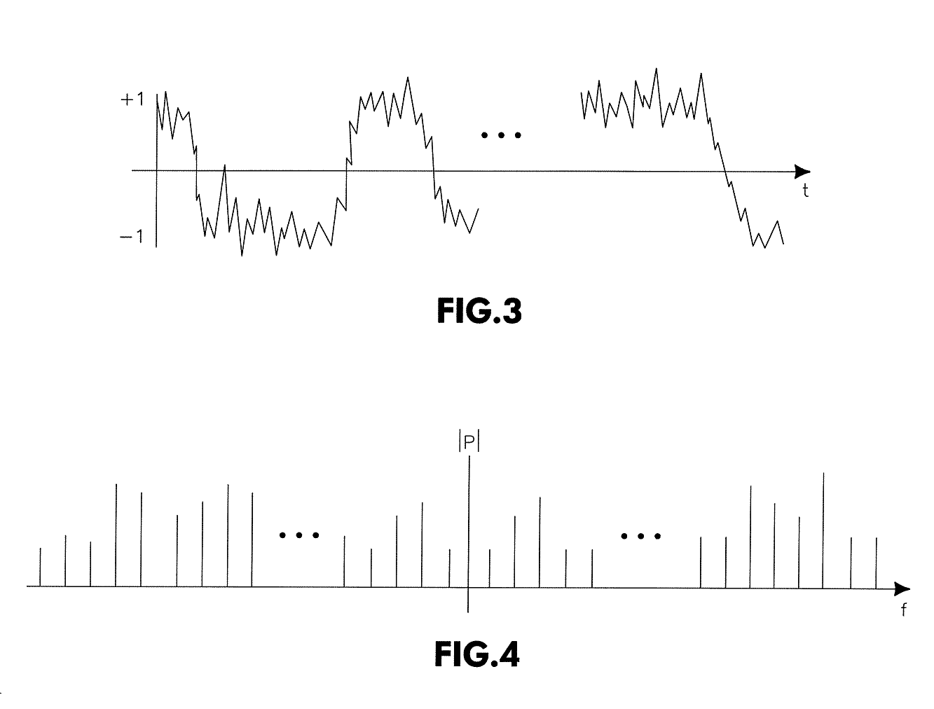

FIG. 1 shows an example of an ideal time domain representation of the real component of a reference signal sequence [c₁, c₂, c₃ . . . cₙ], which is a clean signal response without noise interference. FIG. 2 shows an example of a frequency response corresponding to the time domain representation of the signal sequence of FIG. 1. Note that in the example shown in FIG. 2, the frequency response is symmetrical because the time domain sequence is real. A real component sequence is illustrated here for the sake of easy depiction, however the invention is more general and applies to detection of real values as well as complex valued signals. The steps involved and how the invention is performed is the same for both real and complex valued signals.

FIG. 3 shows the time domain representation of the desired reference signal sequence as shown in FIG. 1, but with additional noise present. FIG. 4 shows the frequency domain representation of the same noisy signal as shown in FIG. 3.

A receiver according to the present invention processes the received signal in both frequency domain and in time domain. When using a correlator in time domain, the noise that falls within the bandwidth of the desired signal is getting incorporated into the decision metric and corrupting it. The received time domain signal would resemble the noisy representation as shown in FIG. 3. The same is true when using filtering in frequency domain and the decision metric degrades. The noise that is corrupting the signal has frequency components that the signal itself does not have. As long as the receiver knows what the original frequency response (or, frequency signature) of the signal is, it can infer that anything that is inconsistent with that frequency response is due to the noise. The receiver can then simply remove those frequency components without destroying the underlying signal. The frequency components introduced by the noise, unless filtered out, will contribute to the decision statistic eventually and reduce its quality. Once the frequency components that are due to noise only and have no bearing on the signal are removed, the time domain detection that follows will have better performance since the effective noise is now reduced.

When comparing the noisy frequency response shown in FIG. 4 against the clean response shown in FIG. 2, it is apparent that the noisy frequency response has many more frequency response components than the clean response. Most short sequences, such as the ones used during time offset and time shift detection at a WTRU's timing acquisition, have a relatively limited set of frequency response components. Therefore, in such applications or any where it is known what sequences are being searched, it can be determined which frequency response components, should be either very weak or absent, which are those that fall outside the frequencies in which the real signal components reside. Since the received frequency response is corrupted by noise, some of the noise in the can be removed by frequency domain processing followed by performing signal detection in the time domain. This is the scenario when the WTRU is establishing a link with the NodeB for the first time, or upon changing cells, or upon waking up after an idle period and needs to re-establish time synchronization with the NodeB. This initial detection of timing by processing the synchronization channel from the NodeB is often called ‘acquisition’. Also, if a short sequence is used with localized frequency response on the synchronization channel (i.e., if the frequency response of the sequence does not include all frequency components in the band), then the WTRU can perform the preferred embodiments of the present invention as described and improve its detection performance. The acquisition process, (i.e. detecting the timing offset with the NodeB and bringing the WTRU into time synchronization with the NodeB), is followed by further messaging for association with the NodeB or call set up messaging.

In short, the frequency response components that are due to the noise only are removed from the received signal and then the remaining signal is processed in a detection algorithm, where the performance of the detection is improved due to reduced noise.

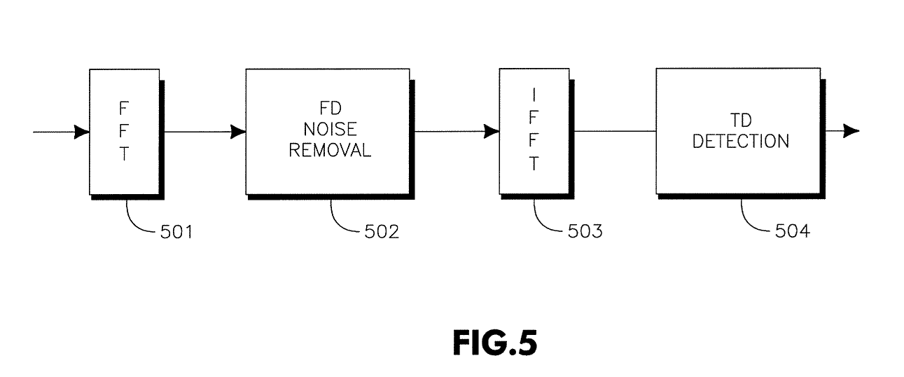

FIG. 5 shows a block diagram of a dual time/frequency filtering and detection algorithm in which noise is removed in frequency domain and the signal timing detection is performed in time domain. As shown in FIG. 5, the algorithm comprises a Fast Fourier transform (FFT) entity 501, a frequency domain noise removal entity 502, an inverse FFT entity 503 and a time domain detection entity 504. The FFT entity 501 converts a received signal to a frequency response. The frequency domain noise removal means 502 performs the filtering of unwanted noise in the frequency response. The IFFT means 503 converts the signal to a time domain signal representation, and the time domain detection entity 504 performs timing detection as described above.

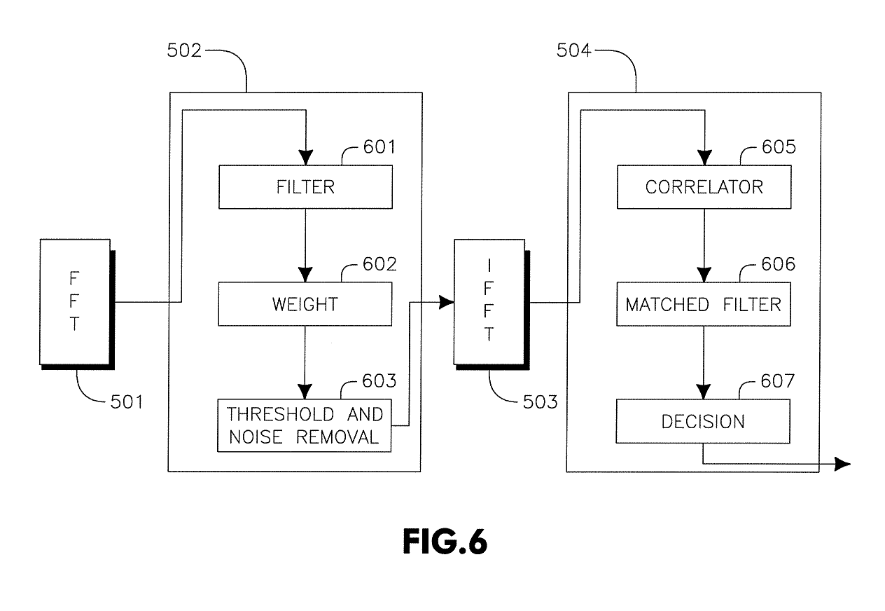

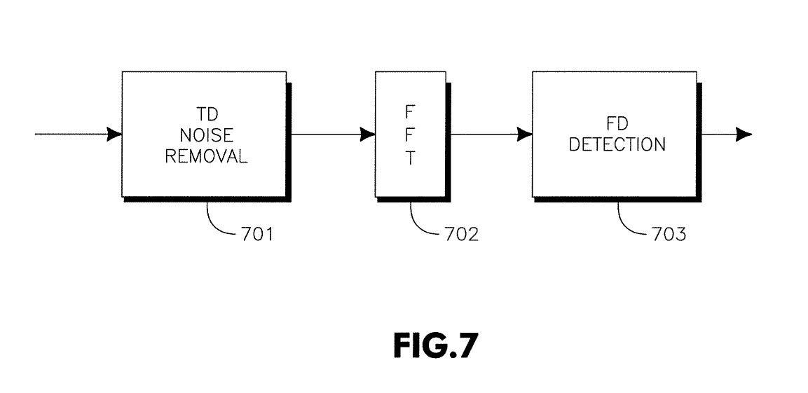

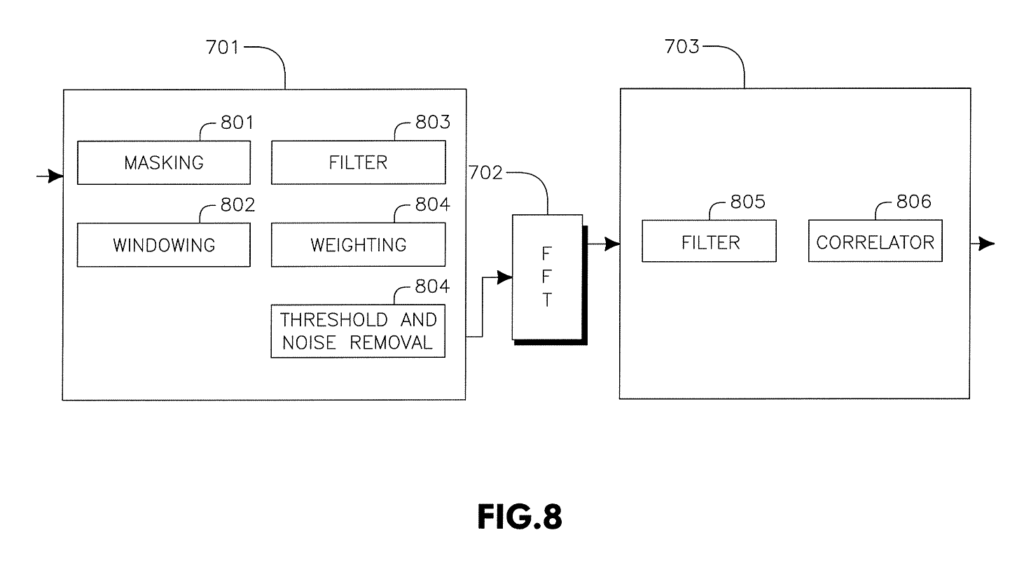

FIG. 6 shows a block diagram of the dual time/frequency filtering and detection algorithm of FIG. 5 in further detail. The frequency domain noise removal entity 502 comprises a filter 601, a weighting unit 602, and a thresholding and noise removal unit 603. The time domain processing 504 includes a correlator 605, a matched filter 606, and optionally includes one or more decision mechanisms 607. The preferred decision mechanisms include, but are not limited to, a sequential probability ratio test (SPRT) unit, and a fixed sample size (FSS) unit. The weighting unit 602 determines and applies weights of the frequency response components at the output of the FFT, (e.g., multiplying by different weights), while the threshold and noise removal unit 603 evaluates the weights components against predetermined acceptable thresholds. The threshold and noise removal unit 603 zeroes out the frequency response components that may have small signal power in order to cut out the associated noise power on these frequency components that may be even more significant than the signal itself. As the amount of noise getting into the detection is reduced, the performance improves.

In an alternative embodiment with reference to FIG. 5, after the FFT 501 operation, the frequency representation of the received signal is sent to the frequency domain noise removal entity 502, where the unwanted frequency components that are deemed to be due to noise only are removed by simply nulling these components, or putting the FFT response through a notched filter, or a frequency domain matched filter. It is possible to zero out the frequency components that are weak and therefore do not significantly contribute to detection. All of these embodiments perform the function of removing unwanted frequency components from the output of the FFT. A matched filter may be implemented using shift register circuits in hardware or as software in a general purpose processor. In short, the signal is converted to frequency domain, then the frequency components that are known not to exist in the reference sequence are canceled (i.e., zeroed out). The modified response is then converted to time domain (now with reduced noise) through the use of the IFFT 503 and time domain processing is performed as usual.

FIG. 6 shows a second embodiment of the present invention complementary to that shown in FIG. 5, wherein the noise removal is performed in the time domain by eliminating the part of the signal sequence known to be outside the sequence to be searched. Then the signal sequence is converted to frequency domain, where the signal detection is performed. The time domain processing 600 comprises a masking unit 601, a matched filter 602, a thresholding and noise removal unit 603. The frequency domain processing 650 includes a matched filter 651 and a correlator 652 for signal timing sequence detection.

This embodiment may be more useful when the synchronization channel includes a signal that has a non-localized spectrum, in other words, when its frequency domain representation includes all or almost all of the frequency components. In that case the UE can not null any of the frequency components at the output of the FFT since that would also cause loss of signal power. In such a scenario, the second embodiment can be used where a time domain processing such as limiting, weightin, or windowing is followed by a frequency domain detection algorithm. In the time domain processing step, the UE can limit the large samples or apply a windowing function. In the frequency domain processing step, the UE can use a frequency domain matched filter, which can be implemented in a similar manner as in time domain case.

Although the features and elements of the present invention are described in the preferred embodiments in particular combinations, each feature or element can be used alone without the other features and elements of the preferred embodiments or in various combinations with or without other features and elements of the present invention. The methods provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for improving detection of a signal sequence by a receiver, the method comprising:
receiving a signal sequence containing a signal component and a noise component in a first domain;
removing the noise component in the first domain based on knowledge of the signal component in the first domain; and
detecting components of the signal sequence in a second domain.

2. The method of claim 1 wherein the first domain is frequency domain and the second domain is time domain, and the knowledge includes a limited set of frequency components in which the signal sequence is present.

3. The method of claim 2, further comprising determining which signal components of the frequency domain are weak or absent.

4. The method of claim 1, wherein the receiver is a wireless transmit/receive unit (WTRU), further comprising the WTRU establishing an initial link with a NodeB.

5. The method of claim 1, wherein the receiver is a wireless transmit/receive unit (WTRU), further comprising the WTRU changing cells.

6. The method of claim 1, wherein the receiver is a wireless transmit/receive unit (WTRU), further comprising the WTRU waking up after an idle period and re-establishing a time synchronization with a NodeB.

7. The method of claim 6, further comprising processing a synchronization channel from the NodeB during an acquisition.

8. The method of claim 7, further comprising using a short sequence with a localized frequency response on the synchronization channel.

9. The method as in claim 1, wherein the detecting components in the second domain includes detecting a timing offset between the WTRU and with the NodeB, further comprising adjusting the timing based on the offset to synchronize the WTRU with the NodeB.

10. The method of claim 1 wherein the first domain is time domain and the second domain is frequency domain and the knowledge includes a limited set of time components in which the signal component is present.

11. The method as in claim 1, wherein the removal of noise includes filtering.

12. The method as in claim 1, wherein the removal of noise includes weighting signal components and thresholding the weighted signal components.

13. The method as in claim 1, wherein the removal of noise includes masking.

14. The method as in claim 1, wherein the removal of noise includes using a matched filter.

15. The method of claim 1, wherein the detecting includes using a correlator, a matched filter and a decision mechanism.

16. The method as in claim 15, wherein the decision mechanism includes a Sequential Probability Ratio Test (SPRT).

17. The method as in claim 15, wherein the decision mechanism includes a fixed sample size (FSS) test.

18. A wireless transmit/receive unit (WTRU) comprising:
a noise removal processor configured to receive a signal sequence containing a signal component and a noise component in a first domain, and to remove the noise component in the first domain based on knowledge of the signal component in the first domain; and
a signal detector configured to detect components of the signal sequence in a second domain.

19. The WTRU of claim 18 wherein the first domain is frequency domain and the second domain is time domain, and the knowledge includes a limited set of frequency components in which the signal sequence is present.

20. The WTRU of claim 19, further comprising determining which signal components of the frequency domain are weak or absent.

21. The WTRU of claim 18, wherein the noise removal processor assists during an establishment of an initial link with a NodeB.

22. The WTRU of claim 18, wherein the noise removal processor assists during the WTRU changing cells.

23. The WTRU of claim 18, wherein the noise removal processor assists during the WTRU waking up after an idle period and re-establishing a time synchronization with a NodeB.

24. The WTRU of claim 23, wherein the signal detector assists with processing a synchronization channel from the NodeB during an acquisition.

25. The WTRU of claim 24, wherein the noise removal processor is configured to process a short signal sequence with a localized frequency response on the synchronization channel.

26. The WTRU as in claim 25, wherein the noise removal processor further comprises a detector configured to detect a timing offset between the WTRU and with the NodeB, the noise removal processor further configured to adjust the timing based on the offset to synchronize the WTRU with the NodeB.

27. The WTRU of claim 18, wherein the first domain is time domain and the second domain is frequency domain and the knowledge includes a limited set of time components in which the signal component is present.

28. The WTRU as in claim 18, wherein the noise removal processor further comprises a filter to remove the noise components.

29. The WTRU as in claim 18, wherein the noise removal processor further comprises a weighting unit configured to weight the signal components and a thresholding unit configured to compare the weighted signal components for establishing the noise components.

30. The WTRU as in claim 18, wherein the noise removal processor further comprises a masking unit.

31. The WTRU as in claim 18, wherein the noise removal processor further comprises a matched filter.

32. The WTRU of claim 18, wherein the detector further comprises a correlator, a matched filter and a decision mechanism.

33. The WTRU as in claim 32, wherein the decision mechanism includes a Sequential Probability Ratio Test (SPRT).

34. The WTRU as in claim 32, wherein the decision mechanism is configured to perform a fixed sample size (FSS) test.
